(19) United States
(12) Patent Application Publication
(10) Pub. No.: US 2013/0246614 A1
(43) Pub. Date: Sep. 19, 2013

(54) METHOD OF UPDATING AGENT SERVICE

(71) Applicant: HON HAI PRECISION INDUSTRY CO., LTD., New Taipei (TW)

(72) Inventors: CHUNG-I LEE, New Taipei (TW); CHIU-HUA LU, New Taipei (TW); TSUNG-HSIN YEN, New Taipei (TW); CHIEN-CHIH LIN, New Taipei (TW)

(73) Assignee: HON HAI PRECISION INDUSTRY CO., LTD., New Taipei (TW)

(21) Appl. No.: 13/751,016

(22) Filed: Jan. 25, 2013

(30) Foreign Application Priority Data
Mar. 19, 2012 (TW) 101109247

(51) Int. Cl. H04L 29/08

(52) U.S. Cl. 709/224

(57) ABSTRACT

A host server electronically connects to one or more agent servers via one or more network ports. Each agent server includes a control module and an agent service that is available to one or more clients. The host server requests the control module and the agent service in an agent server to start each other and monitor running of each other. When the agent service in the agent server needs to be updated, the host server requests the control module to suspend the agent service and write updated data into the agent service to update the agent service. Furthermore, the host server requests the control module to restart the updated agent service.

### BACKGROUND

1. Technical Field

Embodiments of the present disclosure relate to agent service management technology, and more particularly to a method of updating an agent service.

2. Description of Related Art

Agent servers are an intermediary between client computers and networks. Presently, when an agent service provided by the agent servers needs to be updated, a manager may need to write updated data into each of the agent servers one by one via a host server. It is time-consuming if there is many agent servers to be updated. Therefore, there is room for improvement in the art.

### BRIEF DESCRIPTION OF THE DRAWINGS

FIG. 1 is a block diagram of one embodiment of an application environment for utilizing a method of updating an agent service.

FIG. 2 is a flowchart of one embodiment of a method of updating the agent service.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

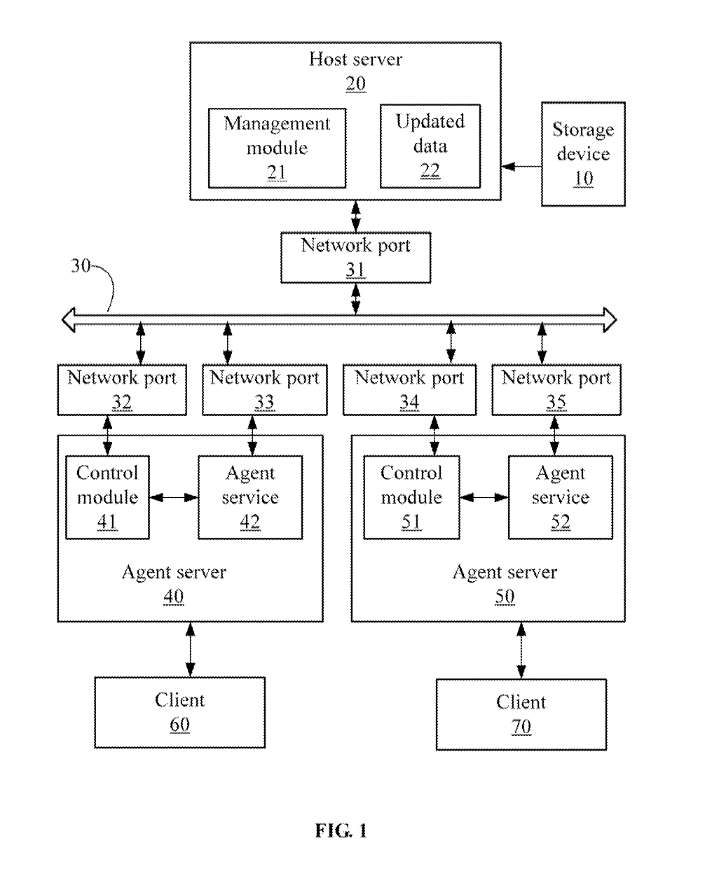

FIG. 1 is a block diagram of one embodiment of an application environment of a method of updating an agent service provided by an agent server. In one embodiment, an agent service is a computer program that acts for a user or other program to perform one or operations, such as uploading data to networks, or downloading data from networks, for example. As shown in FIG. 1, one or more agent servers, such as an agent server 40 and an agent server 50, are electronically connected to a host server 20 via a network 30 and a plurality network ports, such as network ports 31-35 shown in FIG. 1. Each agent server includes a control module and an agent service provided to one or more clients. For example, the agent server 40 includes a control module 41 and agent service 42, and the agent server 50 includes a control module 51 and agent service 52. The host server 20 includes a management module 21 and updated data 22. The updated data 22, loaded to the host server 20 from an external storage device 10, is used to update the agent service provided by the agent servers. The updated data 22 is stored in a non-transitory storage device (not shown) of the host server 20.

Each agent server provides the agent service to one or more clients. For example, the agent server 40 provides the agent service 42 to a client 60, and the agent server 50 provides the agent service 52 to a client 70. The agent service 42 and 52 may be applications for downloading, printing, and browsing data provided by the network 30, for example.

The management module 21 monitors the network port 31, and receives information sent from the agent servers (such as the servers 40 and 50) via the network port 31. The control module and the agent service of each agent server also monitors a pre-assigned network port, and receives information sent from the host server 20 via the pre-assigned network port. For example, the control module 41 and the agent service 42 monitors the network port 32 and the network port 33 respectively, and the control module 51 and the agent service 52 monitors the network port 34 and the network port 35 respectively.

In one embodiment, the management module 21 and the control modules (such as the control modules 41, 51) include computerized code in the form of one or more programs that are stored in non-transitory storage devices (not shown) of the host server 20 and the agent servers (such as the agent servers 40, 50). The computerized code includes instructions that are executed by processors of the host server 20 and the agent servers 30, to provide following functions of the management module 21 and the control modules.

The control module and the agent service in the same agent server (such as the control module 41 and the agent service 42) take charge of starting each other (i.e., turning on each other) and monitor running of each other, so as to ensure that the control module and the agent service in the same agent server works normally on condition that the agent service does not need to be updated. When the agent service needs to be updated, the management module 21 notifies the control module of the same agent server to suspend the agent service, update the agent service by writing the updated data 22 into the agent service, and start the updated agent service. For example, if the agent service 42 needs to be updated, the management module 21 notifies the control module 41 to suspend the agent service 42, write the updated data 22 into the agent service 42 to update the agent service 42, and start the updated agent service 42.

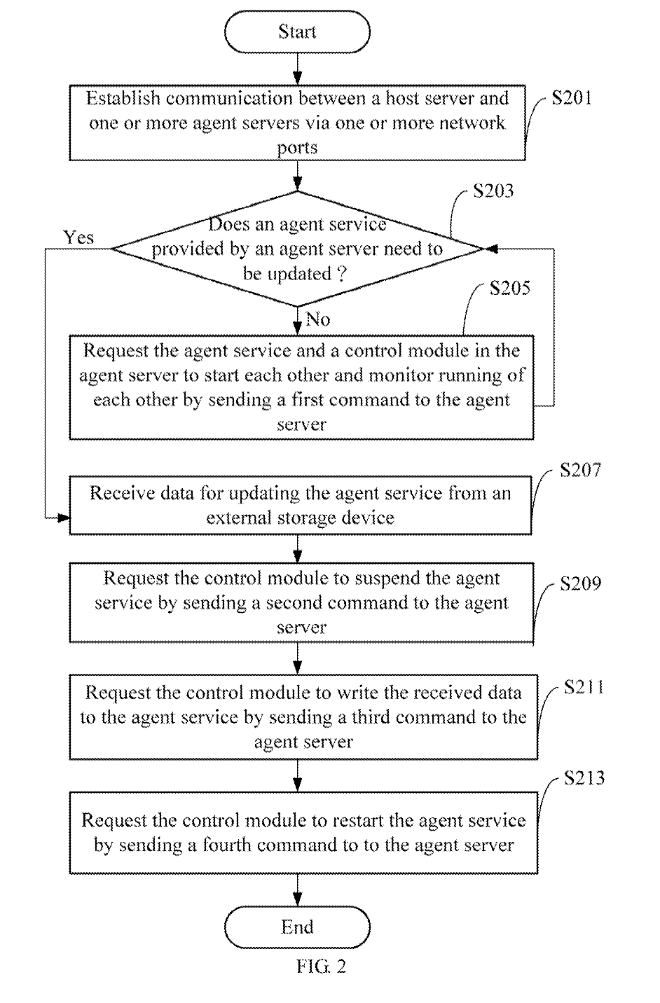

FIG. 2 is a flowchart of one embodiment of a method for updating agent service provided by agent servers. Depending on the embodiment, additional steps may be added, others removed, and the ordering of the steps may be changed.

In step S201, the network 30 establishes communication between the host server 20 and one or more agent servers via one or more network ports. For example, as shown in FIG. 1, the network 30 provides the network port 31 to the management module 21 of the host server 20, provides the network pots 32 and 33 to the agent server 40, and provides the network ports 34 and 35 to the agent server 50. The management module 21 monitors the network port 31, and receives information sent from the agent servers (such as the servers 40 and 50) via the network port 31. The control module and the agent service of each agent server also monitors pre-assigned network ports, and receives information sent from the host server 20 via the pre-assigned network ports. For example, the control module 41 and the agent service 42 monitors the network port 32 and the network port 33 respectively, and the control module 51 and the agent service 52 monitors the network port 34 and the network port 35 respectively.

In step S203, the management module 21 determines if the agent service provided by the agent servers needs to be updated. For example, if the management module 21 receives a command for updating the agent service initiated by a user (e.g., a manager) of the host server 20, the management module 21 determines that the agent service needs to be updated. In one embodiment, the agent servers provide the same agent service. That is, the agent service 42 and the agent service 52 are the same. In other embodiments, the agent servers may provide different agent service, that is, the agent service 42 and the agent service 52 may be different.

In step S203, if the management module 21 determines that the agent service provided by the agent servers does not need to be updated, then step S205 is implemented. The management module 21 requests the control module and the agent service in one agent server to start each other and monitor running of each other by sending a first command to the agent server via pre-assigned network ports. For example, the management module 21 sends the first command to the network port 32 and the network port 33, to notify the control module 41 to start the agent service 42 and monitor running of the agent service 42. According to the first command, the control module will restart the agent service in the same agent server if the agent service is monitored as stopped running or running abnormally, and the agent service will restart the control module if the control module is monitored as stopped running or running abnormally.

Furthermore, the agent server sends back a reply to the management module 21 by the control module and/or the agent service. The reply includes information in relation to whether the control module or the agent service in the agent server runs normally and restart information of the control module and/or the agent service. The restart information includes restart reasons (i.e., why the control module or the agent service is restarted), restart times (i.e., how many times the control module and/or the agent service has restarted), and time for beginning restart operations of the control module and/or the agent service. Then, the procedure returns to step S203 from step S205. In step S203, if the management module 21 determines that the agent service does not need to be updated, step S207 is implemented.

In step S207, the management module 21 receives updated data 22 for updating the agent service from the external storage device, and stores the updated data 22 in the storage device of the host server 20.

In step S209, the management module 21 requests the control module of each agent server to suspend the agent service by sending a second command to the agent server via the pre-assigned network ports. For example, the management module 21 sends the second command to the network ports 32, to notify the control module 41 to suspend the agent service 42 in the agent server 40, and sends the second command to the network port 34, to notify the control module 51 to suspend the agent service 52 in the agent server 50. After the agent service has been suspended, the control module of each agent server sends back a reply to notify the management module 21.

In step S211, the management module 21 requests the control modules to write the received data to the agent service by sending a third command to the control modules via the pre-assigned network ports. For example, the management module 21 sends the third command to the network ports 32, to notify the control module 41 to write the received data into the suspended agent service 42 in the agent server 40, and sends the third command to the network port 34, to notify the control module 51 to write the received data into the suspended agent service 52 in the agent server 50. After the agent service of the agent servers has been updated, the control module of each agent server sends back a reply to notify the management module 21.

In step S213, the management module 21 requests the control modules to restart the agent service of the agent servers by sending a fourth command to the control modules via the pre-assigned network ports. For example, the management module 21 sends the fourth command to the network ports 32, to notify the control module 41 to restart the agent service 42 in the agent server 40, and sends the fourth command to the network port 34, to notify the control module 51 to restart the agent service 52 in the agent server 50. After the agent service of the agent servers has been restarted, the control module of each agent server sends back a reply to notify the management module 21.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a host server for updating an agent service in an agent server, the host server being electronically connected to one or more agent servers via one or more network ports, and each agent server comprising a control module and the agent service, the method comprising:
(a) requesting the control module and the agent service to start each other and monitor running of each other by sending a first command, via pre-assigned network ports, to the agent server by the host server;
(b) requesting the control module to suspend the agent service in the agent server by sending a second command to the agent server via the pre-assigned network ports by the host server; and
(c) requesting the control module to write updated data into the agent service in the agent server by sending a third command to the control module via the pre-assigned network ports by the host server.

2. The method of claim 1, further comprising:
(d) requesting the control module to restart the agent service in the agent server by sending a fourth command to the control module via the pre-assigned network ports by the host server.

3. The method of claim 1, wherein the updated data are received from a first storage device and stored in a second storage device of the host server.

4. The method of claim 1, after step (a) and before step (b) further comprising:
receiving reply information sent by the control module and/or the agent service, wherein the reply information is in relation to whether the control module or the agent service in the agent server runs normally and restart information of the control module and/or the agent service.

5. The method of claim 4, wherein the restart information comprises restart reasons, restart times, and time for beginning restart operations of the control module and/or the agent service.

6. A method being executed by a processor of an agent server for updating an agent service, the agent server being electronically connected to a host server via one or more network ports, and the agent server comprising a control module and the agent service, the method comprising:
(a) in response to receiving a first command, sent by the host server via pre-assigned network ports, the control module and the agent service start each other and monitor running of each other;
(b) in response to receiving a second command, sent by the host server via the pre-assigned network ports, suspending the agent service in the agent server by the control module; and
(c) in response to receiving a third command, sent by the host server via the pre-assigned network ports, writing updated data into the agent service by the control module.

7. The method of claim 6, further comprising:
(d) in response to receiving a fourth command, sent by the host server via the pre-assigned network ports, restarting the agent service in the agent server by the control module.

8. The method of claim 6, after step (a) and before step (b) further comprising: sending a first reply to the host server by the agent server, wherein the first reply comprises information in relation to whether the control module or the agent service in the agent server runs normally and restart information of the control module and/or the agent service.

9. The method of claim 6, wherein the restart information comprises restart reasons, restart times, and time for beginning restart operations of the control module and/or the agent service.

10. The method of claim 6, after step (b) and before step (c) further comprising:
sending a second reply to notify the host server that the agent service has been suspended by the control module.

11. A non-transitory computer-readable medium having stored thereon instructions that, when executed by a processor of a host server, which is electronically connected to at least one agent server comprising a control module and an agent service, via one or more network ports, cause the host server to perform operations of:
(a) requesting the control module and the agent service in an agent server to start each other and monitor running of each other by sending a first command, via pre-assigned network ports, to the agent server by a management module of the host server;
(b) requesting the control module to suspend the agent service in the agent server by sending a second command to the agent server via the pre-assigned network ports by the management module; and
(c) requesting the control module to write updated data into the agent service in the agent server by sending a third command to the control module via the pre-assigned network ports by the management module.

12. The non-transitory medium of claim 11, wherein the operations further comprise:
(d) requesting the control module to restart the agent service in the agent server by sending a fourth command to the control module via the pre-assigned network ports by the management module.

13. The non-transitory medium of claim 11, wherein the updated data are received from a first storage device and stored in a second storage device of the host server.

14. The non-transitory medium of claim 11, after the operation (a) and before the operation (b) further comprising:
receiving reply information sent by the control module and/or the agent service, wherein the reply information is in relation to whether the control module or the agent service in the agent server runs normally and restart information of the control module and/or the agent service.

15. The non-transitory medium of claim 14, wherein the restart information comprises restart reasons, restart times, and time for beginning restart operations of the control module and/or the agent service.

16. A non-transitory computer-readable medium having stored thereon instructions that, when executed by a processor of an agent server, which comprises a control module and an agent service and electronically connects a host server via one or more network ports, cause the agent server to perform operations of:
(a) in response to receiving a first command, sent by the host server via pre-assigned network ports, the control module and the agent service start each other and monitor running of each other;
(b) in response to receiving a second command, sent by the host server via the pre-assigned network ports, suspending the agent service in the agent server by the control module; and
(c) in response to receiving a third command, sent by the host server via the pre-assigned network ports, writing updated data into the agent service by the control module.

17. The non-transitory medium of claim 16, wherein the operations further comprise:
(d) in response to receiving a fourth command, sent by the host server via the pre-assigned network ports, restarting the agent service in the agent server by the control module.

18. The non-transitory medium of claim 16, after the operation (a) and before the operation (b) further comprising:
sending a first reply to the host server by the agent server, wherein the first reply comprises information in relation to whether the control module or the agent service in the agent server runs normally and restart information of the control module and/or the agent service.

19. The non-transitory medium of claim 16, wherein the restart information comprises restart reasons, restart times, and time for beginning restart operations of the control module and/or the agent service.

20. The non-transitory medium of claim 16, after the operation (b) and before the operation (c) further comprising:
sending a second reply to notify the host server that the agent service has been suspended by the control module.
